(19) United States
(12) Patent Application Publication
(10) Pub. No.: US 2018/0046539 A1
(43) Pub. Date: Feb. 15, 2018

(54) ERROR DETECTION CODE GENERATING DEVICE AND ERROR DETECTING DEVICE

(71) Applicant: FUJITSU LIMITED, Kawasaki-shi (JP)

(72) Inventor: Masaru Takehara, Yokohama (JP)

(73) Assignee: FUJITSU LIMITED, Kawasaki-shi (JP)

(21) Appl. No.: 15/622,532

(22) Filed: Jun. 14, 2017

(30) Foreign Application Priority Data
Aug. 15, 2016 (JP) 2016-159239

(51) Int. Cl. G06F 11/10

(52) U.S. Cl. CPC G06F 11/1004

(57) ABSTRACT

An error detection code generating device includes: a detector configured to detect a number of changed bits, which indicates a number of bits changed between transmitted data and a parity of a previous session and transmitted data and a parity of a current session; a generator configured to generate a first add code for a detection of an error based on the number of changed bits detected by the detector and the parity of the transmitted data of the current session; and a compression circuit configured to compress the first add signal generated by the generator and generate a second add code to be added to the transmitted data of the current session.

### CROSS-REFERENCE TO RELATED APPLICATION

This application is based upon and claims the benefit of priority of the prior Japanese Patent Application No. 2016-159239, filed on Aug. 15, 2016, the entire contents of which are incorporated herein by reference.

### FIELD

The embodiments discussed herein are related to an error detection code generating device and an error detecting device.

### BACKGROUND

In a logic circuit, error detection of a data signal transmitted by a data bus is performed by a method that may detect a multi-bit error such as an error-correcting code (ECC). FIG. 12 is a diagram for describing the ECC. FIG. 12 illustrates a case where the width of the data signal is 8 bits as one example.

As illustrated in FIG. 12, by the ECC method, the ECC of 6 bits is generated with respect to the 8-bit data signal and the generated ECC is added to an original data signal to be transmitted through a transmission line. A receiving side may detect an error of two to three bits with respect to the 8-bit data signal using the 6-bit ECC among the received signals.

Further, there is a technology in which data which is output at a previous session and data which is output at a current session are compared with each other for each bit, and when a number of changed bits is equal to or more than a predetermined value, the changed bits are transmitted after a time elapses for stabilizing the fluctuation of bit values in order to ensure that accurate data are transmitted and received.

Further, there is a technology that the number of changed bits of output latch data or an interval between an output latch signal and a strobe internal signal is detected to delay a strobe signal by the detected value, thereby sufficiently securing a timing margin at a receiving side that receives a simultaneous driving output signal even during the high-speed data transmission.

Related technologies are disclosed in, for example, Japanese Laid-Open Patent Publication Nos. 2008-165494 and 2002-300021.

### SUMMARY

According to one aspect of the embodiments, an error detection code generating device includes: a detector configured to detect a number of changed bits, which indicates a number of bits changed between transmitted data and a parity of a previous session and transmitted data and a parity of a current session; a generator configured to generate a first add code for a detection of an error based on the number of changed bits detected by the detector and the parity of the transmitted data of the current session; and a compression circuit configured to compress the first add signal generated by the generator and generate a second add code to be added to the transmitted data of the current session.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a transceiver according to an embodiment;

FIG. 2 is a diagram for describing parity generation by a parity generating unit;

FIG. 3 is a diagram illustrating a circuit example of an extraction unit;

FIG. 4 is a diagram illustrating a truth table which an encoding unit uses for coding;

FIG. 5 is a diagram illustrating a circuit example of the encoding unit;

FIG. 6 is a diagram illustrating a circuit example of a compression unit;

FIG. 7 is a diagram illustrating a signal output by the compression unit;

FIG. 8 is a diagram illustrating a circuit example of a decompression unit;

FIG. 9 is a diagram illustrating an operation of a check unit;

FIG. 10 is a diagram illustrating a circuit example of the check unit;

FIG. 11 is a flowchart illustrating a flow of processing by the transceiver; and

FIG. 12 is a diagram for describing an ECC.

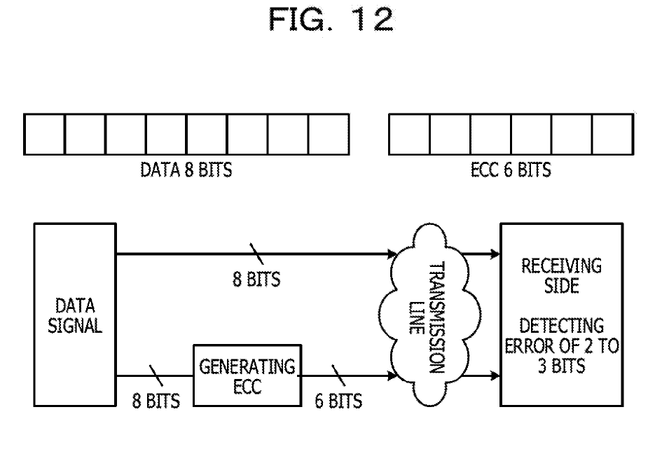

### DESCRIPTION OF EMBODIMENTS

In the ECC, the number of bits applied to the transmission line may be large. When the number of bits applied to the transmission line is large, a routing of wire lines may become difficult, in particular, in a printed board transmission circuit.

The number of applied bits may be reduced as compared with the ECC scheme.

Hereinafter, embodiments of an error detection code generating device and an error detecting device disclosed in the present disclosure will be described in detail based on the accompanying drawings. Further, it is noted that the present disclosure is not limited to the disclosed embodiments.

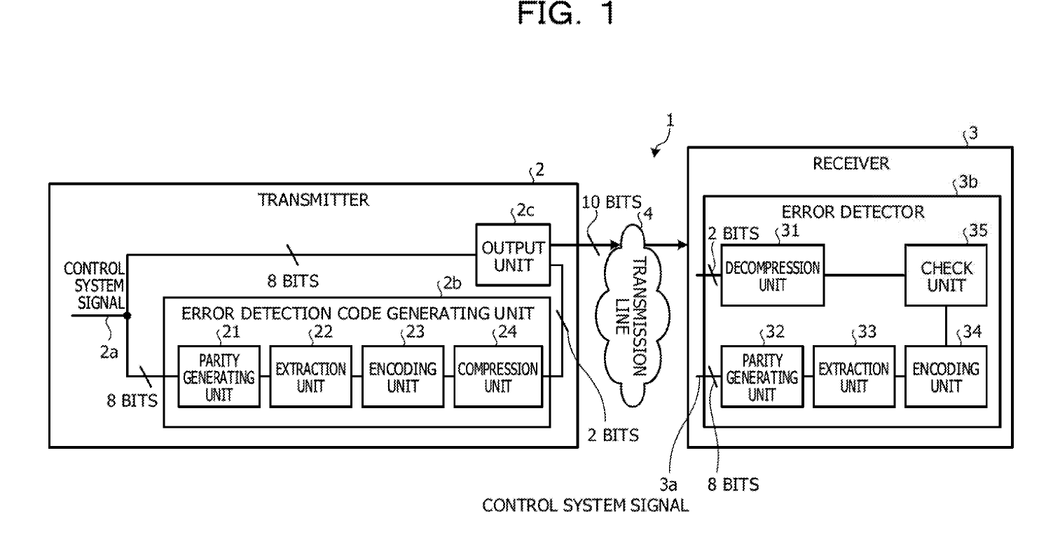

First, the configuration of a transceiver according to an embodiment is described. FIG. 1 is a diagram illustrating the configuration of a transceiver according to an embodiment. As illustrated in FIG. 1, the transceiver 1 according to the embodiment includes a transmitter 2, a receiver 3, and a transmission line 4.

The transmitter 2 adds an error detection bit to a control system signal 2a and transmits the control system signal 2a with the error detection bit to the receiver 3 via the transmission line 4. The transmitter 2 is, for example, a random access memory (RAM). The receiver 3 receives a control system signal 3a added with the error detection bit and checks for an error of the control system signal 3a and thereafter, uses the control system signal 3a. The receiver 3 is, for example, a magnetic disk device.

The control system signal, which is different from data, is a signal used for a communication control between a transmission source of data and a transmission destination of data. When a server or a storage device is used as an example, the control system signal is a signal used for communication with a memory device, an access control thereto or the like. For example, the control system signal may include a RDY signal (ReaDY: a signal indicating data transmission availability), a REQ signal (REQest: a signal indicating an access request), a WE signal (Write Enable: a signal indicating writing validity), a GNT signal (Grant: a signal indicating an access grant), and the like. Besides, the control system signal may include a CE signal (Chip Enable: a signal indicating device validity), an ACK signal (ACKnowledge: a signal indicating access acknowledge), a FRM signal (FRaMe: a signal indicating an access start), an RE signal (Read Enable: a signal indicating reading validity), and the like.

The transmission line 4 transmits the control system signal 2a and the error detection bit. The transmission line 4 is, for example, a printed board transmission circuit. Further, in FIG. 1, a case where the control system signal 2a is 8 bits is illustrated, but the number of bits of the control system signal 2a may be different.

The transmitter 2 includes an error detection code generating unit 2b and an output unit 2c. The error detection code generating unit 2b generates an error detection bit of two bits for detecting an error of the control system signal 3a received by the receiver 3. The output unit 2c adds the error detection bit generated by the error detection code generating unit 2b to the control system signal 2a and outputs the control system signal 2a added with the error detection bit to the transmission line 4.

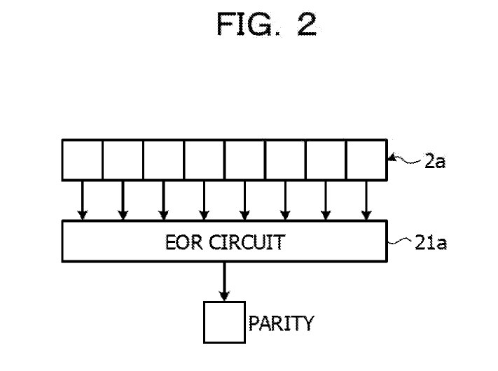

The error detection code generating unit 2b includes a parity generating unit 21, an extraction unit 22, an encoding unit 23, and a compression unit 24. The parity generating unit 21 generates a parity for the control system signal 2a. FIG. 2 is a diagram for describing parity generation by the parity generating unit 21. As illustrated in FIG. 2, the parity generating unit 21 has each bit of the control system signal 2a as an input of an EOR circuit 21a and generates an output of the EOR circuit 21a as the parity.

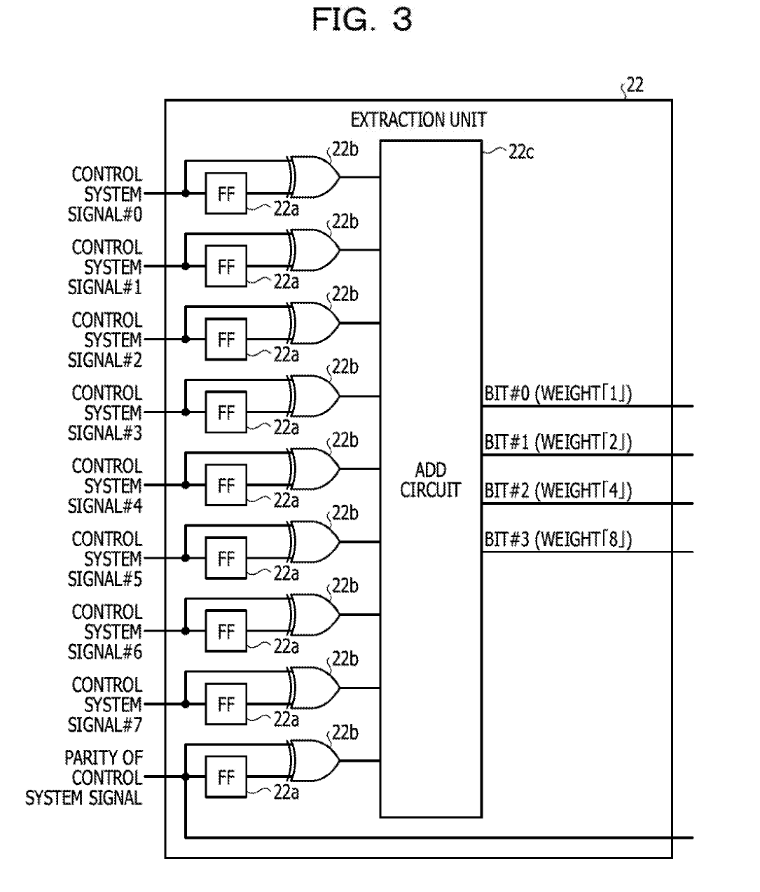

The extraction unit 22 compares the value of the previous session and the value of the current session in respect to the parity generated by the parity generating unit 21 and each bit of the control system signal 2a to output the number of changed bits. FIG. 3 is a diagram illustrating a circuit example of the extraction unit 22. As illustrated in FIG. 3, the extraction unit 22 includes nine FFs 22a, nine EOR circuits 22b, and an add circuit 22c.

The FFs 22a input one bit (one of the control system signals #0 to #7) in the control system signal 2a or the parity of the control system signal 2a, and output one bit or the parity after one clock. For example, the FF 22a outputs the value of the previous session of the one bit in the control system signal 2a or the parity of the control system signal 2a.

The EOR circuit 22b inputs the one bit in the control system signal 2a or the parity of the control system signal 2a and the corresponding output of the FF 22a to output a result of an EOR operation. For example, the EOR circuit 22b outputs “1” when there is a change in the one bit in the control system signal 2a or the parity of the control system signal 2a, and outputs “0” when there is no change in the one bit in the control system signal 2a or the parity of the control system signal 2a.

The add circuit 22c adds and outputs the outputs of nine EOR circuits 22b. For example, the add circuit 22c outputs the number of EOR circuits 22b of which the output is “1” among the nine EOR circuits 22b. The output of the add circuit 22c is four bits of bit #0 to bit #3. The weight of bit #0 is “1”, the weight of bit #1 is “2”, the weight of bit #2 is “4”, and the weight of bit #3 is “8”. The number of changed bits is zero to nine and is expressed as four bits.

The encoding unit 23 encodes the number of changed bits of four bits output by the extraction unit 22 into three bits. An output value of the extraction unit 22 is zero to nine, but the error of a change in odd bits may be detected by the parity, and as a result, the number of changed bits, which is not detected as a parity error, is just five types of 0, 2, 4, 6, and 8. Since five types may be expressed as three bits, the encoding unit 23 encodes the number of changed bits into three bits.

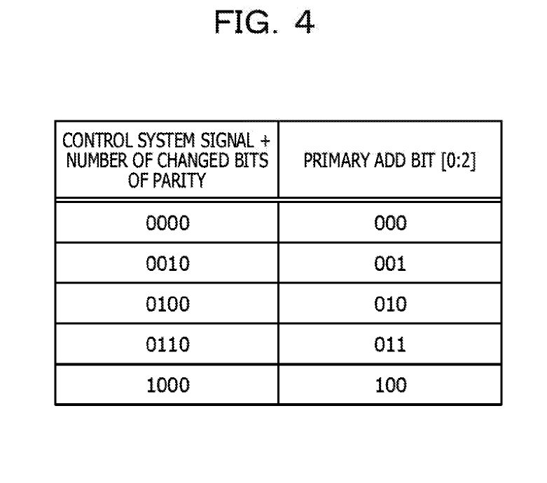

FIG. 4 is a diagram illustrating a truth table which the encoding unit 23 uses for coding. In FIG. 4, a primary add bit indicates the output of the encoding unit 23. As illustrated in FIG. 4, the primary add bit “000” is allocated to the zero number of changed bits, (“0000”), and the primary add bit “001” is allocated to the number two of changed bits, (“0010”). Further, the primary add bit “010” is allocated to the number four of changed bits, (“0100”) and the primary add bit “011” is allocated to the number six of changed bits, (“0110”). In addition, the primary add bit “100” is allocated to the number eight of changed bits, (“1000”).

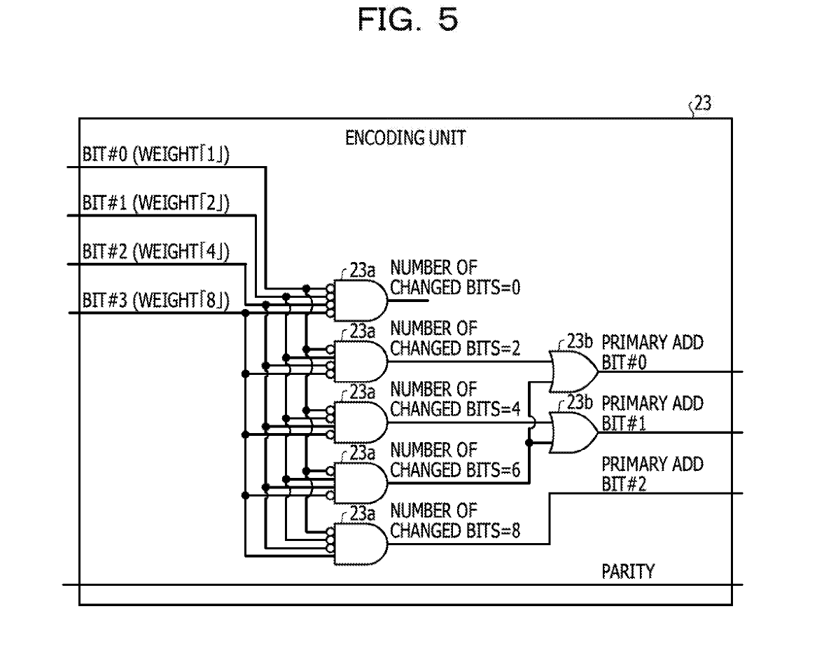

FIG. 5 is a diagram illustrating the circuit example of the encoding unit 23. As illustrated in FIG. 5, the encoding unit 23 includes five AND circuits 23a and two OR circuits 23b. The five AND circuits 23a output “1” when the respective numbers of changed bits are 0, 2, 4, 6, and 8.

When the number of changed bits is two and six, since bit #0 of the primary add bit is “1”, the outputs of two AND circuits 23a that output “1” when the number of changed bits is two and six become the input of the OR circuit 23b that outputs bit #0. When the number of changed bits is four and six, since bit #1 of the primary add bit is “1,” the outputs of two AND circuits 23a that output “1” when the number of changed bits is four and six become the input of the OR circuit 23b that outputs bit #1.

When the number of changed bits is eight, since bit #2 of the primary add bit is “1”, the output of the AND circuit 23a that outputs “1” when the number of changed bits is 8 becomes bit #2 of the primary add bit. Further, the encoding unit 23 inputs and outputs the parity generated by the parity generating unit 21. In addition, in FIG. 5, when the number of changed bits is zero, the AND circuit 23a that outputs “1” may not exist.

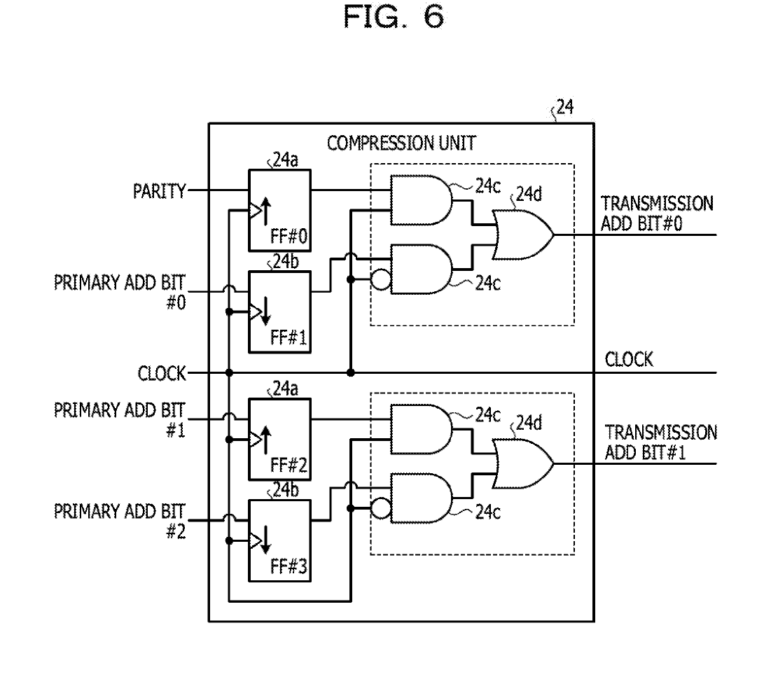

The compression unit 24 receives the 3-bit primary add bit and a parity output from the encoding unit 23, compresses the 3-bit primary add bit and parity into two bits to generate an error detection bit. FIG. 6 is a diagram illustrating the circuit example of the compression unit 24. As illustrated in FIG. 6, the compression unit 24 includes two FFs 24a operating at a rising edge of a clock, two FFs 24b operating at a falling edge of the clock, four AND circuits 24c, and two OR circuits 24d.

The FF #0, which is one of the two FFs 24a operating at the rising edge of the clock, inputs the parity and outputs the parity at the rising edge of the clock. The FF #2, which is the other one of the two FFs 24a operating at the rising edge of the clock, inputs the primary add bit #1 and outputs the primary add bit #1 at the rising edge of the clock.

The FF #1 which is one of two FFs 24b operating at the falling edge of the clock inputs the primary add bit #0 and outputs the primary add bit #0 at the falling edge of the clock. The FF #3 which is the other one of the two FFs 24b operating at the falling edge of the clock inputs the primary add bit #2 and outputs the primary add bit #2 at the falling edge of the clock.

Each AND circuit 24c inputs the output of any one of the FF #0 to FF #3 and the clock. However, the AND circuit 24c that inputs the output of the FF 24b operating at the falling edge of the clock takes and inputs a negating of the clock.

The AND circuit 24c coupled to FF #0 outputs the parity while the clock is “1” from the rising edge of the clock. The AND circuit 24c coupled to the FF #1 outputs the primary add bit #0 while the clock is “0” from the falling edge of the clock. The OR circuit 24d that inputs the outputs of the two AND circuits 24c outputs the parity while the clock is “1” from the rising edge of the clock as transmission add bit #0 and outputs the primary add bit #0 while the clock is “0” from the falling edge of the clock as the transmission add bit #0. Herein, the transmissions add bit is the error detection bit.

The AND circuit 24c coupled to the FF #2 outputs the primary add bit #1 while the clock is “1” from the rising edge of the clock. The AND circuit 24c connected to FF #3 outputs the primary add bit #2 while the clock is “0” from the falling edge of the clock. The OR circuit 24d that inputs the outputs of the two AND circuits 24c outputs a primary add bit #1 while the clock is “1” from the rising edge of the clock as transmission add bit #1 and outputs the primary add bit #2 while the clock is “0” from the falling edge of the clock as transmission add bit #1.

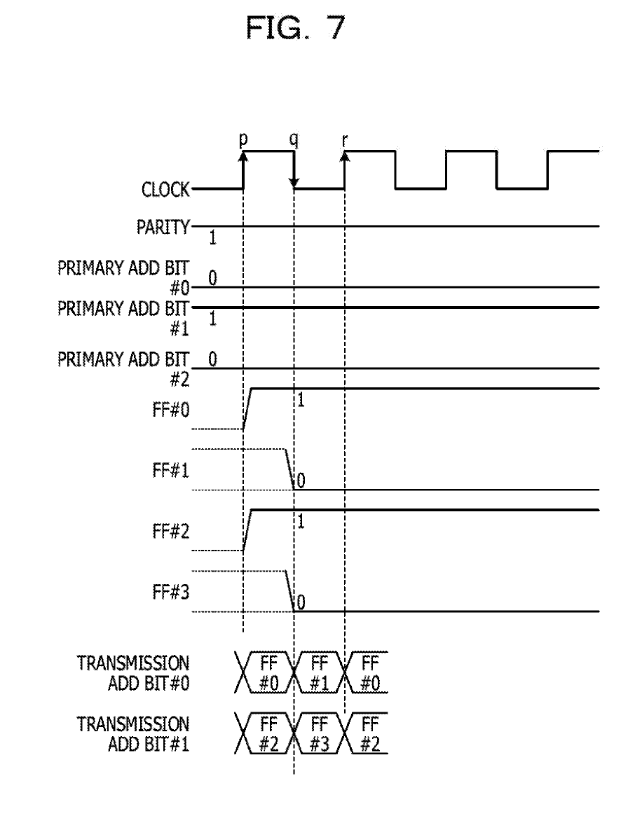

FIG. 7 is a diagram illustrating a signal output by the compression unit 24. FIG. 7 illustrates, clocks, parity, primary add bits #0 to #2, outputs of FF #0 to FF #3, and transmission add bits #0 and #1. FIG. 7 illustrates a case where the parity is “1”, the primary add bit #0 is “0,” the primary add bit #1 is “1”, and the primary add bit #2 is “0”.

As illustrated in FIG. 7, the outputs of the FF #0 and the FF #2 become “1” at the rising edge p of the clock and the outputs of the FF #1 and the FF #3 become “0” at the falling edge q of the clock. In addition, the FF #0 is output to the transmission add bit #0 from p to q, the FF #1 is output to the transmission add bit #0 from q to r, the FF #2 is output to the transmission add bit #1 from p to q, and the FF #3 is output to the transmission add bit #1 from q to r.

Referring back to FIG. 1, the receiver 3 includes an error detector 3b that detects an error of the received control system signal 3a using the transmission add bits #0 and #1. The error detector 3b includes a decompression unit 31, a parity generating unit 32, an extraction unit 33, an encoding unit 34, and a check unit 35.

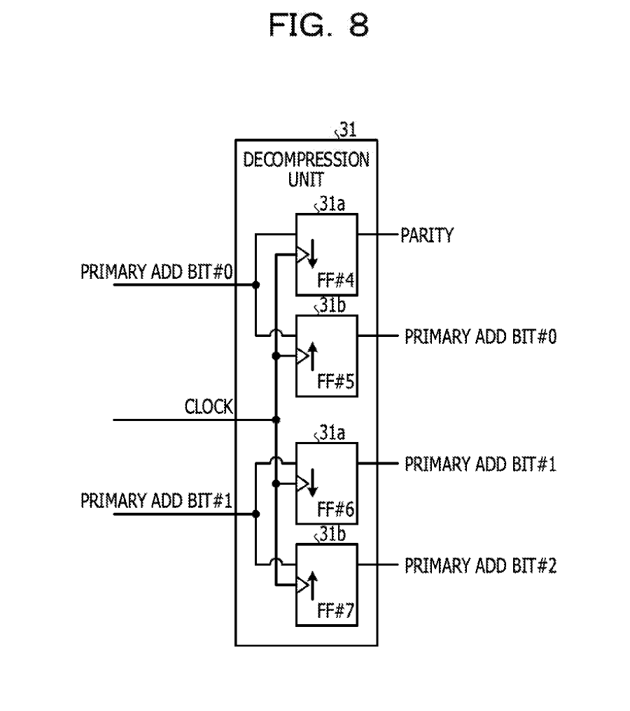

The decompression unit 31 decompresses the transmission add bit to generate the parity and the primary add bit. FIG. 8 is a diagram illustrating the circuit example of the decompression unit 31. As illustrated in FIG. 8, the decompression unit 31 includes two FFs 31a operating at the falling edge of the clock and two FFs 31b operating at the rising edge of the clock.

The FF #4 which is one of the two FFs 31a operating at the falling edge of the clock inputs the transmission add bit #0 and outputs the parity. Since the decompression unit 31 receives the transmission add bit transmitted by the transmitter 2 after a half clock, the decompression unit 31 decompresses the parity transmitted at the rising edge of the clock at the falling edge of the clock. The FF #5 which is one of the two FFs 31b operating at the rising edge of the clock inputs the transmission add bit #0 and outputs the primary add bit #0.

The FF #6 which is the other one of the two FFs 31a operating at the falling edge of the clock inputs the transmission add bit #1 and outputs the primary add bit #1. The FF #7 which is the other one of the two FFs 31b operating at the rising edge of the clock inputs the transmission add bit #1 and outputs the primary add bit #2.

The parity generating unit 32 generates the parity for the received control system signal 3a. The extraction unit 33 compares the value of the previous session and the value of the current session in respect to the parity generated by the parity generating unit 32 and each bit of the control system signal 3a, and outputs the number of changed bits. The encoding unit 34 encodes the number of changed bits of 4 bits output by the extraction unit 33 to 3 bits and generates primary add bits #0 to #2.

The check unit 35 inputs the parity and the primary add bits #0 to #2 decompressed by the decompression unit 31, the parity generated by the parity generating unit 32 and the primary add bits #0 to #2 generated by the encoding unit 34. In addition, the check unit 35 detects whether the error of one to three bits exists in the received control system signal 3a.

For example, the check unit 35 compares the parity decompressed by the decompression unit 31 and the parity generated by the parity generating unit 32 with each other. When both parities do not coincide with each other, the check unit 35 determines that the 1-bit error or the 3-bit error exists in the received control system signal 3a. The check unit 35 compares the primary add bits #0 to #2 decompressed by the decompression unit 31 and the primary add bits #0 to #2 generated by the encoding unit 34 with each other, respectively. In addition, when one or more bits which do not coincide with each other exist and there is neither the 1-bit error nor the 3-bit error, the check unit 35 determines that the 2-bit error exists in the received control system signal 3a.

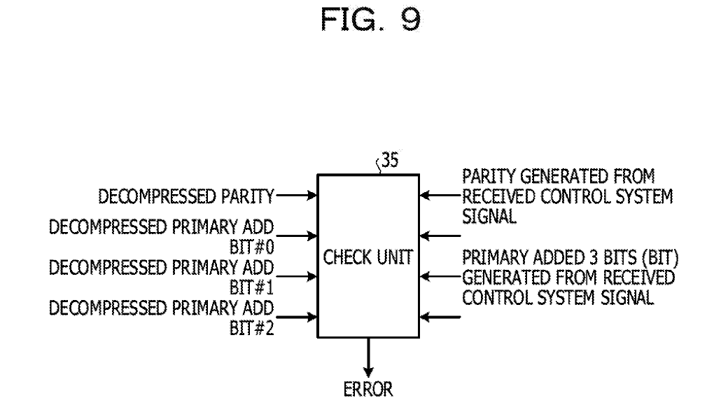

FIG. 9 is a diagram illustrating an operation of the check unit 35. As illustrated in FIG. 9, the check unit 35 inputs the parity and the primary add bits #0 to #2 decompressed by the receiver 3, the parity and the primary add bits #0 to #2 generated by the receiver 3 from the received control system signal 3a, and detects whether there is an error in the received control system signal 3a. The check unit 35 performs an EOR operation of the parity and the primary add bits #0 to #2 decompressed by the receiver 3 and the parity and the primary add bits #0 to #2 generated by the receiver 3, respectively, to determine whether the parity and each bit of the primary add bits #0 to #2 coincide with each other.

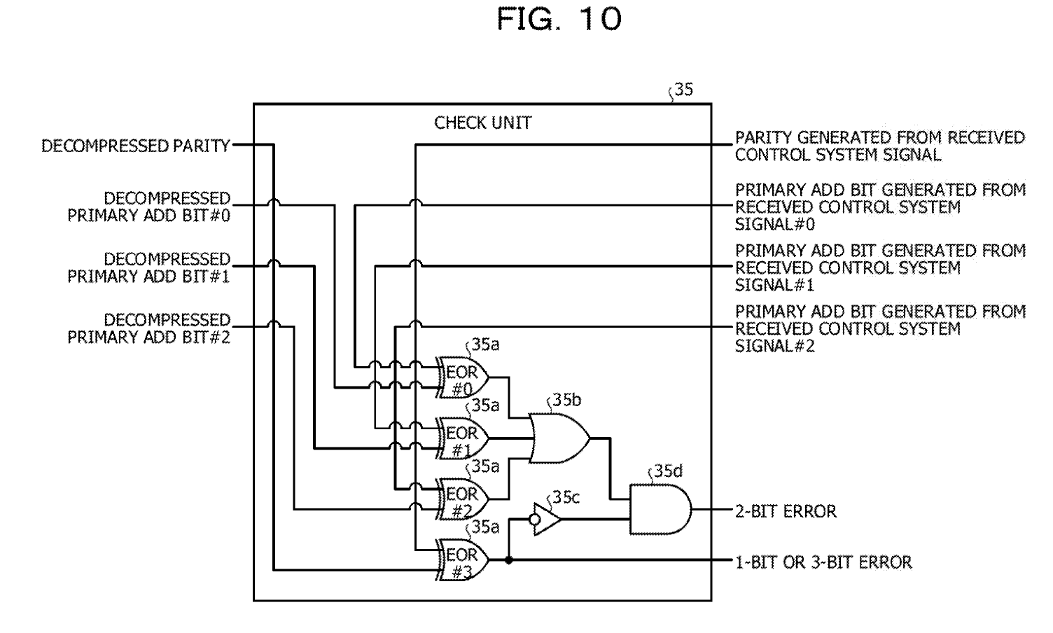

FIG. 10 is a diagram illustrating the circuit example of the check unit 35. As illustrated in FIG. 10, the check unit 35 includes four EOR circuits 35a, an OR circuit 35b, a NOT circuit 35c, and an AND circuit 35d.

The EOR circuit 35a expressed by EOR #0 performs the EOR operation of the primary add bit #0 decompressed by the receiver 3 and the primary add bit #0 generated from the control system signal 3a by the receiver 3. The EOR circuit 35a expressed by EOR #1 performs the EOR operation of the primary add bit #1 decompressed by the receiver 3 and the primary add bit #1 generated from the control system signal 3a by the receiver 3.

The EOR circuit 35a expressed by EOR #2 performs the EOR operation of the primary add bit #2 decompressed by the receiver 3 and the primary add bit #2 generated from the control system signal 3a by the receiver 3. The EOR circuit 35a expressed by EOR #3 performs the EOR operation of the parity decompressed by the receiver 3 and the parity generated from the control system signal 3a by the receiver 3.

When the output of the EOR #3 is “1”, since the parity error is detected, the check unit 35 determines that the 1-bit error or the 3-bit error exists in the received control system signal 3a.

The OR circuit 35b inputs the outputs of the EOR #0 to EOR#2 and performs the OR operation of the input outputs of the EOR #0 to EOR#2. For example, the OR circuit 35b outputs “1” when there are one or more bits which do not coincide among the primary add bits #0 to #2 decompressed by the receiver 3 and the primary add bits #0 to #2 generated from the control system signal 3a by the receiver 3.

The NOT circuit 35c inverts the output of the EOR #3. The AND circuit 35d performs an AND operation of the output of the OR circuit 35b and the output of the NOT circuit 35c. When there are the one or more bits which do not coincide among the primary add bits #0 to #2 decompressed by the receiver 3 and the primary add bits #0 to #2 generated by the receiver 3, there are neither the 1-bit error nor the 3-bit error in the control system signal 3a and there is the 2-bit error, the output of the AND circuit 35d becomes “1”.

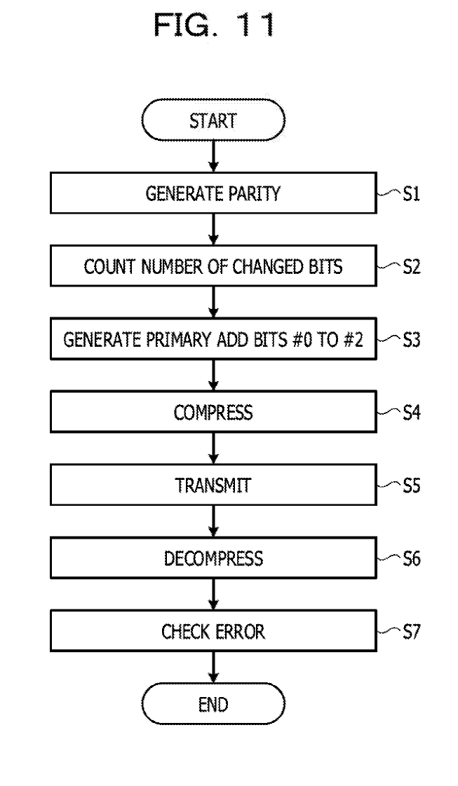

Next, a flow of processing of the transceiver 1 will be described. FIG. 11 is a flowchart illustrating a flow of processing by the transceiver 1. As illustrated in FIG. 11, the transmitter 2 generates the parity for the control system signal 2a (operation S1). In addition, the transmitter 2 compares the value of the previous time and the value of this time with each other with respect to the generated parity and each bit of the control system signal 2a to count the number of changed bits (operation S2).

Furthermore, the transmitter 2 encodes the number of changed bits of four bits to three bits and generates the primary add bits #0 to #2 (operation S3). In addition, the transmitter 2 compresses the parity and the primary add bits #0 to #2 of three bits (operation S4) and generates the transmission add bits #0 and #1 of two bits. In addition, the transmitter 2 transmits the control system signal 2a and the transmission add bits #0 and #1 (operation S5).

The receiver 3 decompresses the received transmission add bits #0 and #1 (operation S6). In addition, the receiver 3 checks the error of the control system signal 3a using the decompressed parity and primary add bits #0 to #2, and the parity and primary add bits #0 to #2 generated from the received control system signal 3a (operation S7).

As described above, since the transceiver 1 detects the error of the control system signal 3a using the transmission add bits #0 and #1 of two bits, the number of added bits may be reduced as compared with the ECC scheme.

As described above, in the embodiment, the extraction unit 22 compares the value of the previous session and the value of the current session in respect to the parity generated by the parity generating unit 21 and each bit of the control system signal 2a to output the number of changed bits. In addition, the encoding unit 23 encodes the number of changed bits of 4 bits to three bits and generates the primary add bits #0 to #2. In addition, the compression unit 24 compresses the parity and the primary add bits #0 to #2 of three bits and generates the transmission add bits #0 and #1 of two bits. Therefore, a transceiver 1 may reduce the number of bits added to the control system signal 2a for detecting the error as compared with the ECC scheme.

In the embodiment, since the compression unit 24 compresses the primary add bit using that two bits are transmitted at one clock by using the rising and the falling in the clock, the number of bits added to the control system signal 2a for detecting the error may be reduced to a half.

In the embodiment, the decompression unit 31 also decompresses the transmission add bit to generate the primary add bits #0 to #2 and the parity. Moreover, the extraction unit 33 compares the value of the previous session and the value of the current session in respect to the parity generated by the parity generating unit 32 and each bit of the control system signal 3a, and outputs the number of changed bits. In addition, the encoding unit 34 encodes the number of changed bits of four bits to three bits and generates the primary add bits #0 to #2. Further, the check unit 35 determines whether there is an error in the control system signal 3a by comparing the primary add bits #0 to #2 and the parity generated by the decompression unit 31 and the primary add bits #0 to #2 generated by the encoding unit 34 and the parity generated by the parity generating unit 32 with each other. Therefore, the receiver 3 may detect the error of one to three bits of the control system signal 3a with the smaller number of bits than that in the ECC scheme.

In the embodiment, the check unit 35 also detects the 1-bit error or 3-bit error by comparing the parity generated by the decompression unit 31 and the parity generated by the parity generating unit 32. In addition, the check unit 35 detects the 2-bit error when there is neither the 1-bit error nor the 3-bit error and there is a difference between the primary add bits #0 to #2 generated by the decompression unit 31 and the primary add bits #0 to #2 generated by the encoding unit 34. Therefore, the check unit 35 may distinguish the 2-bit error and the 1-bit error or the 3-bit error from each other. For example, the check unit 35 may distinguish an even bit error and an odd bit error from each other.

In the embodiment, the case where the control system signal is transmitted is also described, but the present invention is not limited thereto and the embodiment may be similarly applied even to the case where the data signal is transmitted.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An error detection code generating device comprising:
a detector configured to detect a number of changed bits, which indicates a number of bits changed between transmitted data and a parity of a previous session and transmitted data and a parity of a current session;
a generator configured to generate a first add code for a detection of an error based on the number of changed bits detected by the detector and the parity of the transmitted data of the current session; and
a compression circuit configured to compress the first add signal generated by the generator and generate a second add code to be added to the transmitted data of the current session.

2. The error detection code generating device according to claim 1, wherein the compression circuit compresses the first add signal using a scheme in which two bits are transmitted at one clock using a rising of the clock and a falling of the clock.

3. The error detection code generating device according to claim 2, wherein the compression circuit includes:
a first flip-flop operating at the rising of the clock;
a second flip-flop operating at the falling of the clock;
a first AND circuit which receives an output of the first flip-flop and a clock as an input;
a second AND circuit which receives the output of the second flip-flop and a negation of the clock as the input; and
an OR circuit which receives the outputs of the first AND circuit and the second AND circuit as the input.

4. The error detection code generating device according to claim 1, wherein the transmitted data is a control system signal group.

5. An error detecting device comprising:
a decompression circuit configured to decompress a second add code compressed and added to received data of a current session and generate a first add code and a first parity of the received data of the current session;
a parity generation circuit configured to generate a second parity of the received data of the current session based on the received data of the current session;
a detector configured to detect a number of changed bits, which indicates the number of bits changed between received data and a third parity of a previous session and the received data and the second parity of the current session;
a generator configured to generate a third add code based on the number of changed bits detected by the detector and the parity of the received data of the current session; and
a determination circuit configured to determine whether there is an error in the received data of the current session by comparing the first add code and the first parity generated by the decompression circuit and the third add code and the second parity of the received data of the current session generated by the generator with each other.

6. The error detecting device according to claim 5, wherein the determination unit determines whether a number of error bits of the error is an even or odd number.
